(19) United States
(12) Patent Application Publication
(10) Pub. No.: US 2011/0079291 A1
(43) Pub. Date: Apr. 7, 2011

(54) VALVE

(75) Inventors: Thierry BLIN, Strasbourg (FR); Gilles SIMON, Plobsheim (FR); Christophe BRAEM, Eschau (FR)

(73) Assignee: GM GLOBAL TECHNOLOGY OPERATIONS, INC., Detroit, MI (US)

(21) Appl. No.: 12/898,463

(22) Filed: Oct. 5, 2010

(30) Foreign Application Priority Data
Oct. 5, 2009 (GB) 0917376.6

(51) Int. Cl. F15D 1/00; F16K 31/12

(52) U.S. Cl. 137/14; 251/12

(57) ABSTRACT

A valve has a movable valve element extending across a passageway within a housing and a central aperture, either through the valve element itself or in an adjacent part of the housing, which is opened by movement of the valve element to allow fluid flow between an inlet and an outlet.

### CROSS-REFERENCE TO RELATED APPLICATION

This application claims priority to British Patent Application No. 0917376.6, filed Oct. 5, 2009, which is incorporated herein by reference in its entirety.

### TECHNICAL FIELD

The present invention relates to a valve, in particular to a fluid valve. The valve may be used in the engine of a motor vehicle, in particular for supplying oil to the torque converter of an automatic transmission system.

### BACKGROUND

In use of a motor vehicle transmission system, oil is circulated around the components thereof. When a vehicle engine is stopped and subsequently restarted, a problem arises in that during the stop, oil has drained under the effects of gravity from the passageways of the oil circulation system. Thus, when the engine is restarted, there is a delay before the transmission system is fully operational while the empty passageways are refilled with oil.

At least one aspect of the present invention seeks to provide a valve in which the above problem is overcome or reduced, at least for a period of time. In addition, other aspects, desirable features, and characteristics will become apparent from the subsequent summary and detailed description, and the appended claims, taken in conjunction with the accompanying drawings and this background.

### SUMMARY

According to an embodiment of the present invention, there is provided a valve comprising a housing having an inlet, at least one outlet, and a passageway extending between the inlet and the outlet and having walls, and a moveable valve element extending inwardly from the walls across the passageway, the valve having a first portion defining an aperture which is surrounded by the passageway and a second portion for closing the aperture, wherein the valve element is movable between a first disposition, in which said aperture is closed by said second portion to substantially prevent fluid flow, and a second disposition in which said aperture is spaced from said second portion to allow fluid flow.

At least one advantage of this arrangement is that, when closed, the valve is capable of preventing fluid drain back, i.e. unwanted flow of fluid in the reverse direction during periods when there is no forward flow.

In one embodiment said first portion is constituted by a substantially central region of the movable valve element and said second portion is a fixed part of the housing.

This enables the provision of an effective two-way check valve.

In a second embodiment said first portion is constituted by the outlet and said second portion is constituted by a substantially central region of the movable valve element. This enables the provision of an effective three-way check valve.

A method of operating a valve is also provided that comprises a housing having an inlet, at least one outlet, and a passageway extending between the inlet and the outlet and having walls, and a moveable valve element extending inwardly from the walls across the passageway, the valve having a first portion defining an aperture which is surrounded by the passageway and a second portion for closing the aperture, the method comprising raising a pressure applied to said inlet from a zero or low value to a relatively higher value whereby to move the valve element from a first disposition, in which said aperture is closed by said second portion to substantially prevent fluid flow, to a second disposition in which said aperture is spaced from said second portion to allow fluid flow.

### BRIEF DESCRIPTION OF THE DRAWINGS

The present invention will hereinafter be described in conjunction with the following drawing figures, wherein like numerals denote like elements, and:

FIG. 1 shows a sectional view of a valve in accordance with a first embodiment of the present invention in a closed configuration;

FIG. 2 shows the valve of FIG. 1 in an open configuration;

FIG. 3 shows a sectional view of a valve in accordance with a second embodiment of the present invention in a closed configuration;

FIG. 4 shows the valve of FIG. 2 in an open configuration; and

FIG. 5 is a top sectional view of the valve of FIG. 3 along line F-F.

### DETAILED DESCRIPTION

The following detailed description is merely exemplary in nature and is not intended to limit application and uses. Furthermore, there is no intention to be bound by any theory presented in the preceding background or summary or the following detailed description.

When reference is made to the walls or edges of a component, this includes a reference to a single wall or edge if the component is circular. The expressions “upper” and “lower” are used to indicate relative position rather than to be limited to any particular orientation in space.

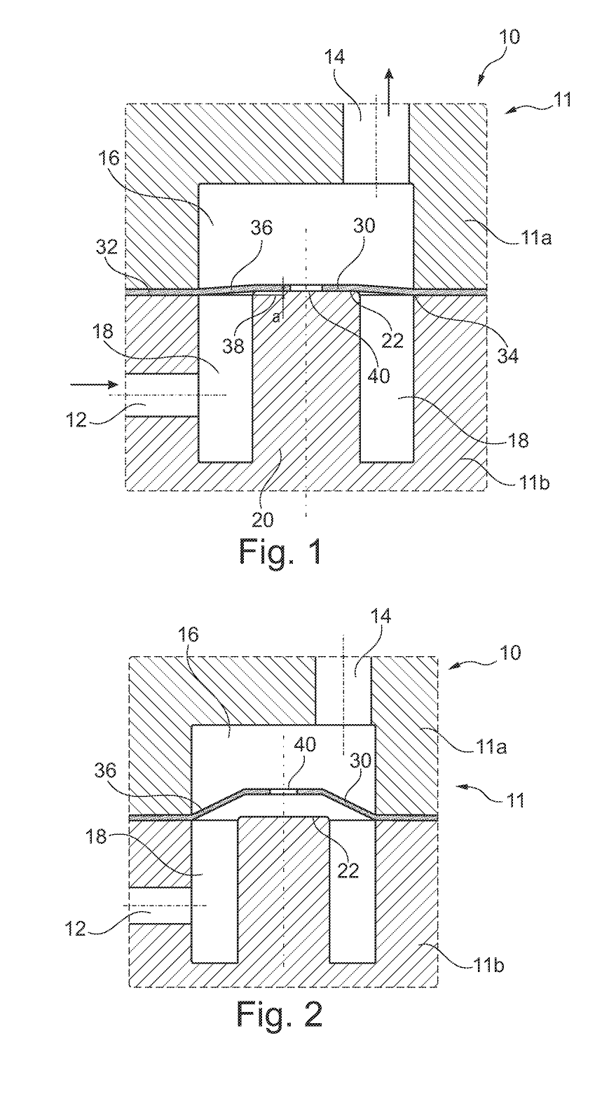

Referring to the drawings, FIG. 1 shows a side sectional view of a two-way check valve 10 in accordance with a first embodiment. The valve comprises a housing 1 having a lower part 11b, through which passes an inlet channel 12 from a pressurized source of oil, and an upper part 11a, through which passes an outlet channel 14 to the components of a motor vehicle transmission system. FIG. 1 shows the situation in which no pressure is being applied via inlet 12.

Between the inlet and outlet there is defined a chamber or passageway comprising an upper part 16 and a lower part 18. Part 16 is substantially circular in plan view and is in fluid communication with outlet channel 14. A solid circular-cylindrical stub portion 20 of housing 11 projects into lower passageway part 18 to form an annular chamber in fluid communication with inlet channel 12. Stub portion 20 has a planar top surface 22.

The upper and lower parts 16 and 18 of the passageway are separated by a movable valve element 30 formed by a membrane. The membrane is an integral part of a rubber seal 32 between the two housing parts 11a, 11b. Thus the circular edge 34 of the membrane valve element is held fixed in position. The rubber material used is REINZ model AFM31.

The membrane 30 has an outer circumferential portion 36 which, in the closed configuration of the valve shown in FIG. 1, bridges the orifice at the top of annular part 18 to close it off from upper part 16. Located radially inwardly from portion 36, the membrane has a substantially central portion 38 having a through aperture 40. In the closed configuration of FIG. 1, aperture 40 abuts against the top surface 22 of stub portion 20.

The surface 22 of portion 20 is slightly higher than the bottom surface of seal 32 by a distance ‘a’. Accordingly membrane 30 is biased by surface 22 to a position slightly higher than one which it would otherwise occupy naturally. Since membrane 30 is of resilient material, it exerts a downward force on surface 22 so as to provide a seal between the top of lower passageway part 18 and aperture 40. This serves to substantially prevent any oil leaking from inlet channel 12 to outlet channel 14 when the valve us in the closed configuration of FIG. 1.

When pressurized oil is supplied to inlet channel 12, the resilient membrane 30 deflects upwardly as shown in FIG. 2 so that aperture 40 is located well clear of surface 22. In this open configuration of the valve 10, oil can flow freely from inlet channel 12 through lower passageway part 18, aperture 40, upper passageway part 16 and outlet channel 14. When the source of pressure is disconnected from inlet channel 12, the membrane 30 reverts to the disposition of FIG. 1 and flow back of oil is substantially prevented.

An advantage of the above-described arrangement is that the valve automatically closes when no pressure is applied. In the closed configuration, the membrane prevents the oil from leaking from the inlet to the outlet. In addition it also prevents air from entering the inlet via the outlet. Accordingly the inlet channel is always filled with oil, which in turn has the advantage of increasing the speed of response when an oil flow is needed. For example, when used in the oil feed to a torque converter in an automatic transmission, the torque converter remains filled with oil even after several hours of non-use; this has the advantage of allowing a quick start.

A further advantage of the above-described arrangement is that, by suitable adjustment or calibration of the dimensions of the membrane and the various apertures and orifices, the opening of the valve can be triggered to occur at a desired pressure or flow rate.

The aperture 40 is relatively large, so that oil can flow substantially unimpeded through the valve. Because the membrane is part of a seal, there is no path for the leakage of oil at the walls of the passageway. As shown, the diameter of aperture 40 is substantially equal to half of the diameter of the stub portion 20. This leaves enough of central portion 38 to provide effective sealing.

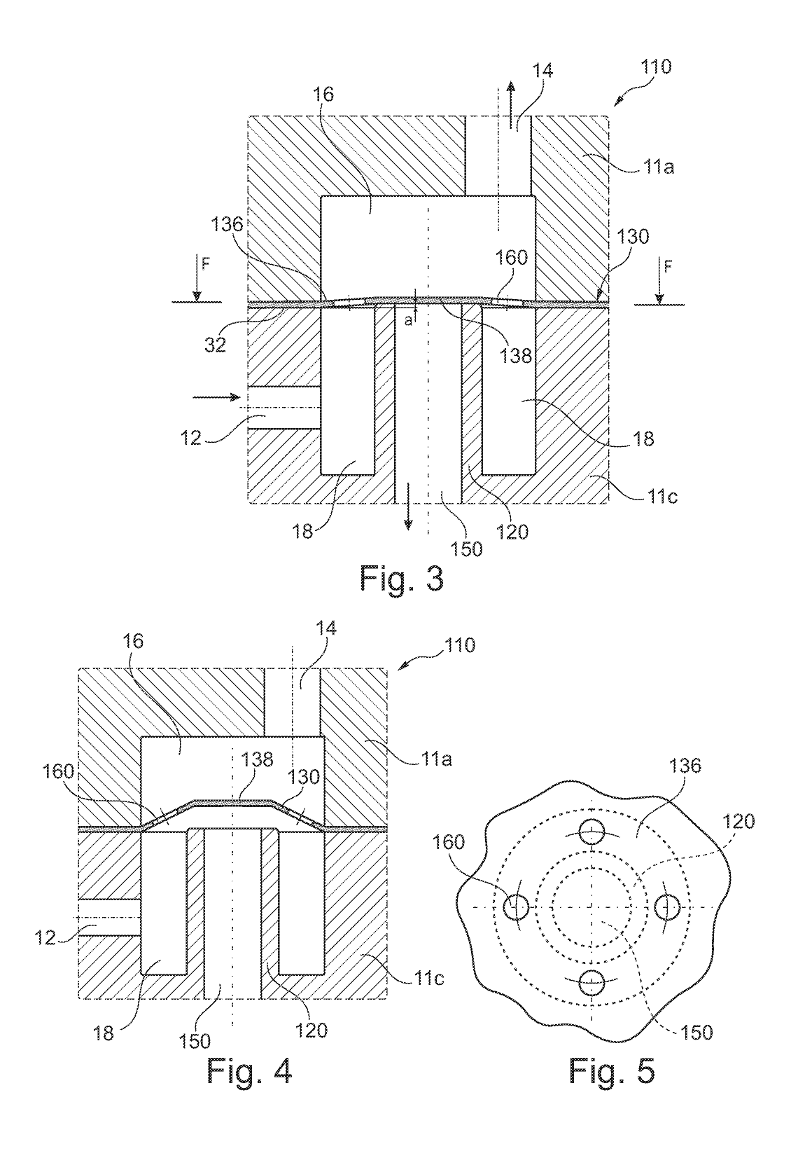

Referring now to FIG. 3 to FIG. 5, there is shown a three-way check valve 110 in accordance with a second embodiment of the present invention. Integers in common with the embodiment of FIG. 1 and FIG. 2 are identified by the same reference numerals. The second embodiment has a different arrangement of the lower housing part 11c and the membrane/valve element 130. In addition to inlet 12 and outlet 14, the valve 110 has an additional or secondary outlet 150 which passes though lower housing part 11c and opens into the passageway through a hollow, circular-cylindrical channel portion 120. Portion 120 is located substantially centrally of the lower annular part 18 of the passageway.

Resilient membrane 130 is part of a flexible seal 32 between housing parts 11a, 11c. It has a circumferential portion 136 which bridges the orifice at the top of annular part 18 and has four though holes 160 (see also FIG. 5), which provide permanent fluid communication between passageway parts 18 and 16.

Membrane 130 further comprises a solid portion 138 located radially inwardly from portion 136. In the partially-closed configuration of the valve shown in FIG. 3, portion 138 substantially closes the orifice at the top of secondary outlet 150. Accordingly oil can flow from inlet 12 only to outlet 14. The resilience and configuration of membrane 130, and in particular portion 138, serve to substantially prevent any oil leaking from inlet channel 12 to outlet channel 150.

When the pressure or flow rate prevailing at inlet channel 12 rises above a predetermined threshold value, holes 160 are no longer capable alone of passing the oil flow and membrane 130 is displaced into the configuration shown in FIG. 4, in which the valve 110 is open to both outlets. Substantially central portion 138 has been moved clear of the end of outlet 150 so that oil can freely flow from inlet 12 to outlet 150. Apertures 160 are located so that they continue to permit flow from inlet 12 into upper passageway part 16 and thence to outlet 14. When the pressure level at inlet 12 falls below a second threshold value, lower than the first-mentioned threshold value, the membrane 130 reverts to the disposition of FIG. 3, and flow into outlet 150 is substantially prevented.

The arrangement in accordance with the second embodiment has the same advantages as the first embodiment.

Instead of four holes 160, the valve 110 may have any number of holes arranged in any desired pattern.

In a modification of the second embodiment, the valve has two separate membranes, a lower membrane corresponding to membrane 130, and an upper membrane corresponding to membrane 30 and overlying the lower membrane. The lower membrane is more resistant to pressure than the upper membrane; in other words the upper membrane is more resilient. Such an arrangement acts as a two-stage valve. With no or low pressure, the valve is completely closed. Upon the pressure exceeding a first threshold, the upper membrane lifts and flow is permitted from inlet 12 to outlet 14. Upon the pressure being raised beyond a second threshold, the lower membrane also lifts and flow is permitted from inlet 12 to both outlets 14 and 150. It has to be ensured that the upper membrane does not block the apertures in the lower membrane when both membranes are lifted.

The membrane moves between its two dispositions in a continuous manner, its final position depending on the flow. Alternatively, it may jump from one disposition to the other when a particular threshold is reached. The membrane can be made of any suitable material with sealing and elastic capabilities. It can be made of a plastic material combined with a separate spring. Alternatively, it can comprise paper or rubber adhered to a thin metal sheet.

Instead of being inherently resilient, the membrane may be biased into its closed position by a separate spring member.

Instead of being a membrane with fixed edges, the movable valve element may take a number of different forms. For example, it may be constructed by a resiliently-biased disc which slides within the passageway or chamber. Alternatively, the movable valve element may be a resiliently-biased pivotal flap. In these modifications, the housing portions 20, 120 do not need to be centrally located, but can be located at a side of the passageway.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A valve, comprising:
a housing;
an inlet of the housing;
an one outlet of the housing,
a passageway extending between the inlet and the outlet;
walls of the housing; and
a moveable valve element that extends inwardly from the walls across the passageway;
a valve element comprising a first portion defining an aperture surrounded by the passageway and a second portion adapted to close the aperture,
wherein the valve element is movable between a first disposition in which said aperture is closed by said second portion to substantially prevent fluid flow, and a second disposition in which said aperture is spaced from said second portion to allow fluid flow.

2. A valve according to claim 1, wherein said first portion is constituted by a substantially central region of the movable valve element and said second portion is a fixed part of the housing.

3. A valve according to claim 2, wherein the fixed part of the housing comprises a cylindrical stub portion having a planar end surface and, in said first disposition, the substantially central region of the movable valve element abuts said planar end surface.

4. A valve according to claim 2, wherein said outlet is located at an opposite side of the movable valve element to the inlet.

5. A valve according to claim 1, wherein said first portion is constituted by the outlet and said second portion is constituted by a substantially central region of the movable valve element.

6. A valve according to claim 5,
wherein said outlet is a first outlet; and
the valve further comprises a second outlet which is in permanent fluid connection with said inlet, said movable valve element having one or more through holes which are located radially of said substantially central region and which, in both said first disposition and the second disposition, maintain fluid connection from said inlet, through said passageway to, said second outlet.

7. A valve according to claim 6, wherein said first outlet comprises a hollow cylindrical channel portion of the housing located at the same side of the movable valve element as said inlet.

8. A valve according to claim 2, wherein edges of the movable valve element are fixedly attached to the walls and the substantially central region of the movable valve element moves relatively thereto.

9. A valve according to claim 1, wherein the housing comprises:
two housing parts; and
a sealing member between the two housing parts, and
wherein the movable valve element is an integral part of said sealing member.

10. A valve according to claim 1, wherein the movable valve element is a resilient membrane.

11. A valve according to claim 1, wherein the valve element is arranged to be moved between the first disposition and the second disposition by the fluid pressure.

12. A method of operating a valve comprising a housing having an inlet, at least one outlet, and a passageway extending between the inlet and the outlet and having walls, and a moveable valve element extending inwardly from the walls across the passageway, the valve having a first portion defining an aperture which is surrounded by the passageway and a second portion for closing the aperture, the method comprising:
raising a pressure applied to said inlet from a low valve to a relatively higher value to move the moveable valve element from a first disposition, in which said aperture is closed by said second portion to substantially prevent fluid flow, to a second disposition in which said aperture is spaced from said second portion to allow fluid flow.
